(19) United States
(12) Patent Application Publication
(10) Pub. No.: US 2026/0152080 A1
(43) Pub. Date: Jun. 4, 2026

(54) SYSTEM AND METHOD FOR WIRELESS CHARGING

(71) Applicant: GM GLOBAL TECHNOLOGY OPERATIONS LLC, Detroit, MI (US)

(72) Inventors: Ahmed F. Al Alawy, Canton, MI (US); Azin Neishaboori, Plymouth, MI (US); Richard Fernandes, Farmington Hills, MI (US); Venkata Naga Siva Vikas Vemuri, Farmington Hills, MI (US)

(73) Assignee: GM GLOBAL TECHNOLOGY OPERATIONS LLC, Detroit, MI (US)

(21) Appl. No.: 18/968,055

(22) Filed: Dec. 4, 2024

(51) Int. Cl. B60L 53/126; B60L 53/124; B60L 53/62; B60L 53/66

(52) U.S. Cl. CPC B60L 53/126; B60L 53/124; B60L 53/62; B60L 53/66

(57) ABSTRACT

A method of operating a wireless charging assembly for wirelessly charging a device. The method includes detecting the device located adjacent to a wireless charging assembly and detecting a foreign object adjacent to the wireless charging assembly by measuring a weight of the device with a scale in the wireless charging assembly. The method also includes collecting at least one operating parameter regarding the device, the wireless charging assembly, or an environment surrounding the wireless charging assembly and calculating a heat dissipation for the device. Additionally, the method includes determining a charge rate for the wireless charging assembly to apply the device based on at least one of the foreign object detected, the at least one operating parameter, or the heat dissipation.

### BACKGROUND

The present disclosure relates to wirelessly charging devices, and more particularly, to a system and method that optimizes a wireless charging rate.

Fully electric or hybrid electric vehicles are capable of achieving greater range through advancements in battery technology and capacity. Certain batteries, such as traction batteries, provide power in the form of direct current (“DC”). The DC power from the traction battery can be converted to alternative current (“AC”) by a power module to drive a traction motor or operate another portion of the vehicle. In some instances, traction batteries are recharged through regenerative braking or from an external power source that is selectively connectable to the traction battery. The vehicle may also be able to utilize power from the traction battery to charge other devices, such as a mobile device, within a passenger compartment of the vehicle.

### SUMMARY

Disclosed herein is a method of operating a wireless charging assembly for wirelessly charging a device. The method includes detecting the device located adjacent to a wireless charging assembly and detecting a foreign object adjacent to the wireless charging assembly by measuring a weight of the device with a scale in the wireless charging assembly. The method also includes collecting at least one operating parameter regarding the device, the wireless charging assembly, or an environment surrounding the wireless charging assembly and calculating a heat dissipation for the device. Additionally, the method includes determining a charge rate for the wireless charging assembly to apply the device based on at least one of the foreign object detected, the at least one operating parameter, or the heat dissipation.

In one aspect of the disclosure the method includes applying the charging rate to the device with a coil in the wireless charging assembly.

In one aspect of the disclosure the at least one operating parameter includes at least one of a battery capacity, a predetermined weight, an operating temperature range, an acceptable heat dissipation range, or a presence of an accessory for the wireless charging the device.

In one aspect of the disclosure the at least one operating parameter includes historical charging data for the device.

In one aspect of the disclosure the at least one operating parameter includes an available charging rates for the wireless charging assembly.

In one aspect of the disclosure the at least one operating parameter includes an ambient temperature surrounding the wireless charging assembly.

In one aspect of the disclosure detecting the foreign object includes comparing the weight measured by the wireless charging assembly to a predetermined weight for the device detected.

In one aspect of the disclosure detecting the device includes identifying the device from a wireless communication between the device and the wireless charging assembly.

In one aspect of the disclosure detecting the device includes receiving an image of the device and performing object detection on the image to identify the device.

In one aspect of the disclosure determining the charge rate is based on an available charge duration and a current battery charge level for the device.

Disclosed herein is a wireless charging assembly. The assembly includes a charging pad configured to generate a magnetic field, a scale configured to measure a weight, and a controller. The controller is configured to detect a device located adjacent to a wireless charging assembly and detect a foreign object adjacent to the wireless charging assembly by measuring a weight of the device with a scale in the wireless charging assembly. The controller is also configured to collect at least one operating parameter regarding the device, the wireless charging assembly, or an environment surrounding the wireless charging assembly and calculate a heat dissipation for the device. Additionally, the controller is configured to determine a charge rate for the wireless charging assembly to apply the device based on at least one of the foreign object detected, the at least one operating parameter, or the heat dissipation.

In one aspect of the disclosure the wireless charging assembly includes a coil and the controller is configured to apply the charging rate to the device utilizing the coil.

In one aspect of the disclosure the at least one operating parameter includes at least one of a battery capacity, a predetermined weight, an operating temperature range, an acceptable heat dissipation range, or a presence of an accessory for the wireless charging the device.

In one aspect of the disclosure the at least one operating parameter includes historical charging data for the device, an available charging rates for the wireless charging assembly, or an ambient temperature surrounding the wireless charging assembly.

In one aspect of the disclosure the controller is configured to detect the foreign object by being configured to compare the weight measured by the wireless charging assembly to a predetermined weight for the device detected.

In one aspect of the disclosure the controller is configured to detect the device from a wireless communication between the device and the wireless charging assembly.

In one aspect of the disclosure detecting the device includes receiving an image of the device and performing object detection on the image to identify the device.

Disclosed herein is a vehicle. The vehicle includes a body at least partially defining a passenger cabin, wheels supporting the body, and a wireless charging assembly located within the passenger cabin. The assembly includes a charging pad configured to generate a magnetic field, a scale configured to measure a weight, and a controller. The controller is configured to detect a device located adjacent to a wireless charging assembly and detect a foreign object adjacent to the wireless charging assembly by measuring a weight of the device with a scale in the wireless charging assembly. The controller is also configured to collect at least one operating parameter regarding the device, the wireless charging assembly, or an environment surrounding the wireless charging assembly and calculate a heat dissipation for the device. Additionally, the controller is configured to determine a charge rate for the wireless charging assembly to apply the device based on at least one of the foreign object detected, the at least one operating parameter, or the heat dissipation.

In one aspect of the disclosure the wireless charging assembly includes a coil and the controller is configured to apply the charging rate to the device utilizing the coil.

In one aspect of the disclosure determining the charge rate is based on an available charge duration and a current battery charge level for the device.

### BRIEF DESCRIPTION OF THE DRAWINGS

The accompanying drawings, which are incorporated into and constitute a part of this specification, illustrate implementations of the disclosure and together with the description, explain the principles of the disclosure.

FIG. 1 schematically illustrates a vehicle with a rechargeable energy storage system (RESS) wireless charging assembly and a wireless charging assembly associated with the vehicle.

FIG. 2 schematically illustrates wireless charging assembly associated with the vehicle of FIG. 1.

FIG. 3 is a flow diagram of an example method of operating one of the wireless charging assemblies shown in FIG. 1.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps.

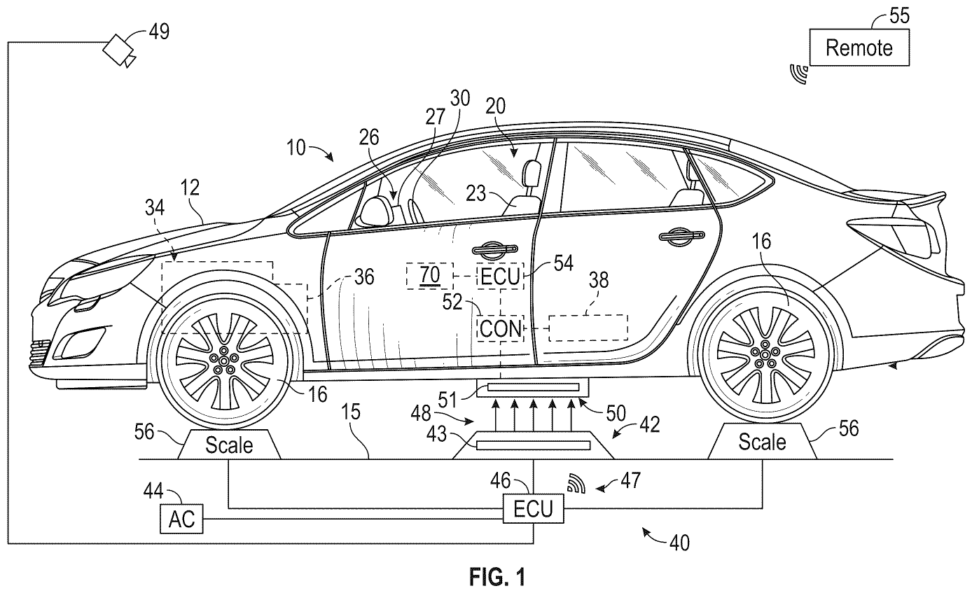

A vehicle, in accordance with a non-limiting example, is indicated generally at 10 in FIG. 1. In the illustrated example, the vehicle 10 includes a body 12 supported on wheels 16 with one or more of the wheels 16 being steerable. The body 12 defines, in part, a passenger compartment 20 having seats 23 positioned behind a dashboard 26. A steering control 30 is arranged between the seats 23 and the dashboard 26. The steering control 30 is operated to control orientation of the steerable wheel(s) 16.

The vehicle 10 includes an electric motor 34 connected to a transmission 36 that provides power to one or more of the wheels 16. A rechargeable energy storage system (RESS) 38 is arranged in the body 12 and provides power to the electric motor 34. However, the location of the electric motor 34, the transmission 36, and the RESS 38 relative to the body 12 may vary from those illustrated in FIG. 1.

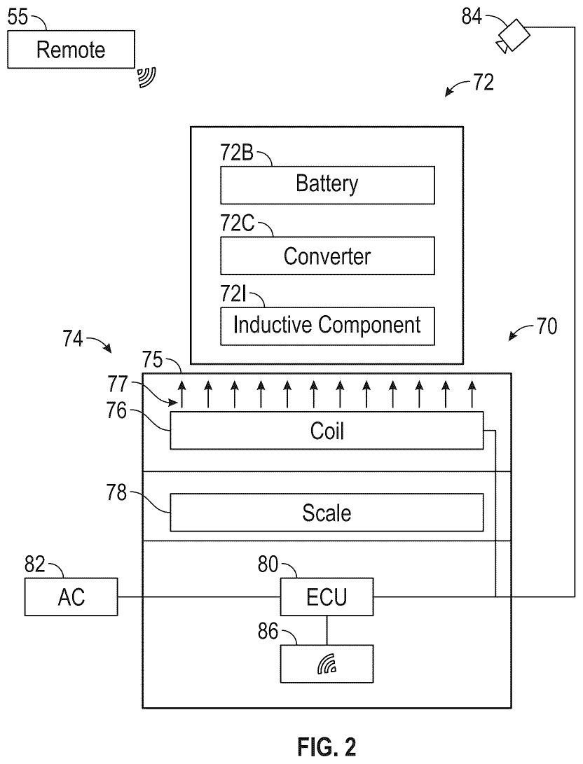

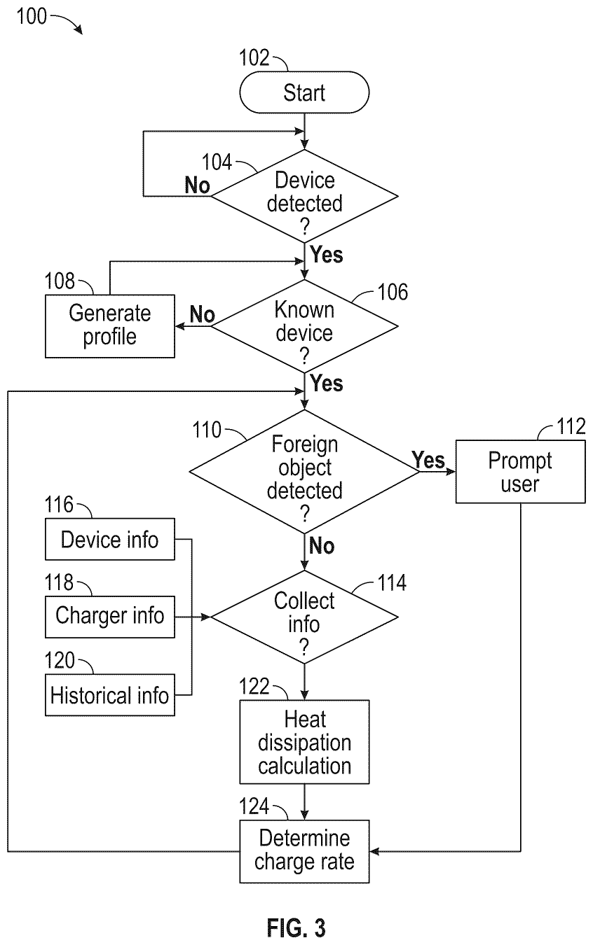

As shown in FIG. 1, a RESS wireless charging assembly 40 is configured to provide power to the vehicle 10 to charge the RESS 38 without forming a direct electrical connection with a charge port on the vehicle 10. One feature of this disclosure is to wirelessly provide electrical power to another device with the rate of power transfer optimized based on a number of different parameters as will be discussed in greater detail below. While FIG. 1 illustrates wirelessly charging the vehicle 10 with the assembly 40, this disclosure applies to other types of devices 72 (FIG. 2) that can be wirelessly charged as discussed with respect to FIGS. 2 and 3.

In the illustrated example of FIG. 1, the assembly 40 includes an electronic control unit (ECU) 46 in electrical communication with a wireless charging pad 42, an alternating current (AC) power source 44, at least one sensor 54, and at least one scale 56. While the illustrated example shows separate scales 56 for each of the wheels 16, a single scale 56 could be used to weigh the entire vehicle 10 at a given time. The scales 56 and the charging pad 42 are supported by a road surface 15 and are in electrical communication with the ECU 46. The AC power source 44 can be remote from the assembly 40 or located adjacent to the assembly 40, such as with an electric vehicle (EV) charging station.

To wirelessly charge the RESS 38 on the vehicle 10 with the assembly 40, the ECU 46 selectively applies AC power from the AC power source 44 to the charging pad 42. When the AC power is applied to the charging pad 42, a magnetic field 48 is generated by a coil 43 within the charging pad 42 with the magnetic field 48 being directed towards an inductive component 50 the vehicle 10.

When the inductive component 50 on the vehicle 10 is within the range of the magnetic field 48, an AC power is induced in the inductive component 50. In one example, the inductive component 50 includes a coil 51 located therein for inducing the AC power. The AC power generated within the inductive component 50 can be converted to direct current (DC) through a converter 52 controlled by an ECU 54 on the vehicle 10 to charge the RESS 38 with DC power. Alternatively, the AC power generated by the inductive component 50 can be directed by the ECU 54 to portions of the vehicle 10 that operate on AC power.

The sensor 49 can include at least one of an optical sensor or a radar based sensor positioned adjacent to the assembly 40 such that it includes a field of view of the charging pad 42. In one example, the sensor 49 is used to determine if there is a vehicle present to be charged by the assembly 40. In another example, the sensor 49 obtains images of the area surrounding the charging pad 42 for performing objection detection with either the ECU 46 or by transferring the images through a data connection 47, such as a Bluetooth, Wi-Fi, or network connection, to a computer at a remote location 55. The object detection can identify the vehicle 10 or objects adjacent to the charging pad 42, such as debris, which could interfere with charging the vehicle 10. The object detection can also be used to identify a model of the vehicle for obtaining information regarding the vehicle 10 for optimizing the charge rate produced by the assembly 40. The information regarding the vehicle 10 can be stored in memory on the ECU 46 or at the remote location 55 that is communicated to the ECU 46 for optimizing the charge rate.

As shown in FIGS. 1-2, the vehicle 10 can also include an additional wireless charging assembly 70. As shown in FIG. 1, the assembly 70 is integrated or onboard the vehicle 10 and in FIG. 2 the assembly 70 is shown separate or independent of the vehicle 10, such that the assembly 70 could be used within a residential or commercial space or another location with access to an AC power source.

As shown in the illustrated example of FIG. 2, the assembly 70 includes a charging pad 74, a scale 78, at least one sensor 84, and an ECU 80. The charging pad 74 includes a device support surface 75 for supporting the device 72 thereon. The ECU 80 is configured to selectively apply the AC power from an AC power source 82 to a coil 76 located within the charging pad 74. As shown in FIG. 1, the AC power source 82 could be provided by the vehicle 10 and as shown in FIG. 2 the AC power source can come from another source such as an outlet at a residential or commercial building. The ECU 80 can also communicate with the scale 78 for weighing the device 72 when placed on the charging pad 74.

In this disclosure, an ECU, such as the ECUs 46, 54, or 80, may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described SOC functionality in prior figures, as well as different functions identified by the CC input signal. The ECU also includes an associated non-transitory computer-readable storage medium, i.e., memory (M) inclusive of read only, programmable read only, random access, a hard drive, etc., whether resident, remote or a combination of both. Control routines, including code for executing the SOC model with hysteresis, are executed by the processor to monitor relevant inputs from sensing devices and other networked control modules (not shown), and to execute control and diagnostic routines to govern operation of the vehicle 10 or assemblies 40 and 70.

While the assembly 40 is configured to charge larger devices, such as the vehicle 10, the assembly 70 is configured to wirelessly charge devices 72 that are smaller or handheld. For example, the devices 72 charged by the assembly 70 could include mobile phones, tablets, laptop computers, interchangeable battery packs, or power tools. As shown in the illustrated example of FIG. 2, the devices 72 include or are in electrical communication with an inductive component 72I. When inductive component 72I interacts with the magnetic field 77 generated by the charging pad 74, an AC power is induced therein. The device 72 can convert the AC power to DC power with a converter 72C for changing a battery 72B integrated into the device 72.

The sensor 84 can include at least one of an optical sensor or a radar based sensor positioned adjacent to the assembly 70 such that it includes a field of view of the support surface 75 on the charging pad 74. In one example, the sensor 84 is used to determine if a device 72 is located on the charging pad 74. In another example, the sensor 84 obtains images of the area surrounding the charging pad 74 for performing objection detection with either the ECU 80 or by transferring the images through a data connection 86, such as a Bluetooth, Wi-Fi, or network connection, to the computer at the remote location 55. The object detection can identify objects adjacent to the charging pad 74, such as debris, which could interfere with charging the device 72. The object detection can also be used to identify the device 72 for obtaining information regarding device 72 for optimizing the charge rate produced by the assembly 70.

The assembly 40 or 70 can identify when a device, such as the vehicle 10 or the device 72, is ready to be charged by utilizing scales 56 or 78, respectively, to weigh the device. In one example, the scale 78 in the assembly 70 can aid in identifying a specific device 72 that has a predetermined and consistent weight, such as mobile phones or tablets. In another example, the scale 56 in the assembly 40 can aid in identifying a class of device, such as passenger car, truck, or heavy duty vehicle. The sensors 49 and 84 can aid determining if the vehicle 10 or device 72 are located adjacent to the charging pad 42 or 74, respectively. Furthermore, the sensors 49 and 84 with or without the scales 56 and 78, respectively, can identify foreign objects, such as debris, which may interference with the charging process.

FIG. 3 illustrates an example method 100 of operating the assembly 40 or 70 for performing wireless charging. The method 100 begins at block 102 (“Start”) and then proceeds to block 104. At block 104 (“Device Detected?”), the method 100 detects if a device, such as the vehicle 10 or the device 72, is located adjacent to the assembly 40 or 70. If no device is detected, the method 100 returns to block 104 and continues monitoring for a device. The method 100 detects the device with the assembly 40 or 70 through a number of different approaches, such as by measuring changes in electromagnetic induction in the charging pads 42 or 74, by wireless communications between the device and the assembly 40 or 70, by weighing the device with the scale 56 and 78, respectively. The assembly 40 and 70 can also utilize data, such as image data or radar base data, from the at least one sensor 54 or 84, respectively, to detect the device. Once the device has been detected adjacent to the assembly 40 or 70 as described above, the method 100 proceeds to block 106.

At block 106 (“Known Device?”), the method 100 determines if the device detected in block 104 is a known device. The method 100 can determine if the device detected from block 104 is a known device through a number of different approaches. In one example, the detected device communicates wirelessly with the assembly 40 or 70. The method 100 can determine if the assembly 40 or 70 has previously communicated with the device based on information communicated from the device that identifies the device by model or manufacturer or if the device was previously charged by one of the assemblies 40 or 70.

In another example, the method 100 can determine if the device detected from block 104 is a known device by utilizing images captured by the at least one sensor 54 or 84 from the assembly 40 or 70, respectively. The captured images are evaluated with an object detection algorithm to determine if the detected device is known. The method 100 can also allow a user to confirm that the detected device is known or allow the user to select from a list of possible known devices on a display 27 (FIG. 1) on the dashboard 26 of the vehicle 10.

In yet another example, the method 100 can determine if the detected device is recognized by utilizing the scale 56 or 78 from the assembly 40 or 70, respectively, to weigh the detected device. With the weight of the detected device measured, the method 100 can determine if the weight matches the weight of one of the known devices. One feature of utilizing weight of the device as part of the identification process is that a predetermined weight for a device can be updated if user customizations change the weight, such as attaching a case to a mobile device or utilizing different size batteries with the device.

If the device is not known to the assembly 40 or 70, the method 100 proceeds to block 108 and generates a profile for the device. The profile can include information regarding the device that has been collected as described above, including weight, images, or other data that was transferred through a wireless communication between the device and the assembly 40 or 70. With the profile generated at block 108, the method 100 returns to block 106 and confirms that the device is known before proceeding to block 110.

At block 110 (“Foreign Object Detected”), the method 100 determines if a foreign object is detected adjacent to the assemblies 40 or 70. In one example, the assemblies 40 or 70 can detect foreign objects, such as objects not capable of being wirelessly charged on the charging pads 42 or 74, respectively, by comparing the measured weight to a predetermined weight for the given object. This comparison can be performed when the device was identified through wireless communications, object detection, or by the measured weight being within a predetermined range of weight. For example, if the device is identified through image detection or wireless communications and a difference between the predetermined weight exceeds a weight threshold. If the weight threshold exceeds a predetermined amount, then the method 100 proceeds to block 112 (“Prompt User”) and the user is notified of the possible foreign object. The user can then confirm if there is a foreign object present on the assembly 40 or 70 or potentially remove the foreign object. If no foreign object is detected at block 110, the method 100 proceeds to block 114.

At block 114 (“Collect Info”), information regarding operating parameters of the device and the assembly 40 or 70 is collected from blocks 116, 118, or 120. At block 116 (“Device Info”), information regarding the device is provided to block 114. The device information can include a battery capacity, a predetermined weight, a maximum charge rate, an acceptable operating temperature range, an acceptable range of heat dissipation values, or the presence of accessories on the device, such as a case for a mobile device.

At block 118 (“Charger Info”), information regarding the assembly 40 or 70 is provided to block 114. In one example, the information includes ambient temperature, available charging rates, or type of wireless charging assembly, such as a wireless charge assembly for handheld devices or large scale devices, such as vehicles.

At block 120 (“Historical Data”), historical charging data for the device is provided to block 114. The historical charging data can include charge rates previously applied to the device and associated heat dissipation levels, or charge durations with associated changes in battery level. In another example, the historical data can include historical vehicle trip information including trip durations.

The information from blocks 116, 118, or 120 can be stored in memory of the ECU 46 or 80 or communicated to the assembly 40 or 70 from the remote location 55. With the information collected at block 114, the method 100 proceeds to block 122.

At block 122 (“Heat Dissipation Calculation”), the method 100 performs a heat dissipation calculation to determine an amount of heat dissipated from the device while charging. The heat dissipation calculation can be performed by applying a first charge rate to the device for a first period of time beginning at a first known battery level for the device and determining a predicted charge level for the device based at least partially on the first charge rate and the info collected at block 114 over the first period of time. The predicted charge level for the device is then compared to an actual charge level for the device. The heat dissipation can then be determined based on a comparison between the predicted charge level and the actual charge level for the device. With the heat dissipation calculation performed, the method 100 then proceeds to block 124.

At block 124 (“Determine Charge Rate”), the method 100 determines a charge rate for the device based on the above information. In particular, the charge rate can be determined based on at least one of the information collected at block 114, the presence of a foreign object, or the head dissipation calculation. The method 100 can then determine an acceptable charge rate based on these inputs. In one example, the different inputs are evaluated in a charge rate matrix to determine a desirable charge rate. For example, if the available charge duration is above a predicted charge duration needed to fully charge the device, the method could determine that the device could be charged at a lower rate to improve battery life.

In another example, the above inputs are each given a score and the charge rate determined is based on a sum of that score falling within predetermined ranges. For example, when a sum of the scores exceeds a maximum value, the charge rate for the device is reduced and when the sum of the scores is below a minimum value, the charge rate for the device increases. Furthermore, when the score is between the minimum value and the maximum valve, the charge rate can remain unchanged.

Once the charge rate has been determined, the method 100 returns to block 110 to continue monitoring for foreign objects, changes in information collected at block 114, or changes in the heat dissipation to determine if further changes to the charge rate should be made when the method 100 returns to block 124.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. A method of operating a wireless charging assembly for wirelessly charging a device, the method comprising:
detecting the device when the device is located adjacent to the wireless charging assembly;
detecting a foreign object adjacent to the wireless charging assembly by measuring a weight of the device with a scale in the wireless charging assembly;
collecting at least one operating parameter regarding the device, the wireless charging assembly, or an environment surrounding the wireless charging assembly;
calculating a heat dissipation for the device; and
determining a charge rate for the wireless charging assembly to apply the device based on at least one of the foreign object detected, the at least one operating parameter, or the heat dissipation.

2. The method of claim 1, including applying the charging rate to the device with a coil in the wireless charging assembly.

3. The method of claim 1, wherein the at least one operating parameter includes at least one of a battery capacity, a predetermined weight, an operating temperature range, an acceptable heat dissipation range, or a presence of an accessory for the wireless charging the device.

4. The method of claim 3, wherein the at least one operating parameter includes historical charging data for the device.

5. The method of claim 3, wherein the at least one operating parameter includes one or more available charging rates for the wireless charging assembly.

6. The method of claim 5, wherein the at least one operating parameter includes an ambient temperature surrounding the wireless charging assembly.

7. The method of claim 1, wherein detecting the foreign object includes comparing the weight measured by the wireless charging assembly to a predetermined weight for the device detected.

8. The method of claim 1, wherein detecting the device includes identifying the device from a wireless communication between the device and the wireless charging assembly.

9. The method of claim 1, wherein detecting the device includes receiving an image of the device and performing object detection on the image to identify the device.

10. The method of claim 1, wherein determining the charge rate is based on an available charge duration and a current battery charge level for the device.

11. A wireless charging assembly, comprising:
a charging pad configured to generate a magnetic field;
a scale configured to measure a weight of a device positioned adjacent to the wireless charging assembly; and
a controller configured to:
detect the device located adjacent to the wireless charging assembly;
detect a foreign object adjacent to the wireless charging assembly by measuring the weight of the device with the scale in the wireless charging assembly;
collect at least one operating parameter regarding the device, the wireless charging assembly, or an environment surrounding the wireless charging assembly;
calculate a heat dissipation for the device; and
determine a charge rate for the wireless charging assembly to apply the device with the wireless charging pad based on at least one of the foreign object detected, the at least one operating parameter, or the heat dissipation.

12. The wireless charging assembly of claim 11, wherein the wireless charging assembly includes a coil and the controller is configured to apply the charging rate to the device utilizing the coil.

13. The wireless charging assembly of claim 11, wherein the at least one operating parameter includes at least one of a battery capacity, a predetermined weight, an operating temperature range, an acceptable heat dissipation range, or a presence of an accessory for the wireless charging the device.

14. The wireless charging assembly of claim 13, wherein the at least one operating parameter includes historical charging data for the device, an available charging rates for the wireless charging assembly, or an ambient temperature surrounding the wireless charging assembly.

15. The wireless charging assembly of claim 11, wherein the controller is configured to detect the foreign object by being configured to compare the weight measured by the wireless charging assembly to a predetermined weight for the device detected.

16. The wireless charging assembly of claim 11, wherein the controller is configured to detect the device from a wireless communication between the device and the wireless charging assembly.

17. The wireless charging assembly of claim 11, wherein detecting the device includes receiving an image of the device and performing object detection on the image to identify the device.

18. A vehicle comprising:
a body at least partially defining a passenger cabin;
a plurality of wheels supporting the body; and
a wireless charging assembly located within the passenger cabin, wherein the wireless charging assembly includes:
a charging pad configured to generate a magnetic field;
a scale configured to measure a weight of a device positioned adjacent to the wireless charging assembly;
a controller configured to:
detect the device located adjacent to the wireless charging assembly;
detect a foreign object adjacent to the wireless charging assembly by measuring the weight of the device with the scale in the wireless charging assembly;
collect at least one operating parameter regarding the device, the wireless charging assembly, or an environment surrounding the wireless charging assembly;
calculate a heat dissipation for the device; and
determine a charge rate for the wireless charging assembly to apply the device with the wireless charging pad based on at least one of the foreign object detected, the at least one operating parameter, or the heat dissipation.

19. The vehicle of claim 18, wherein the wireless charging assembly includes a coil and the controller is configured to apply the charging rate to the device utilizing the coil.

20. The vehicle of claim 18, wherein determining the charge rate is based on an available charge duration and a current battery charge level for the device.
